(19) United States
(12) Patent Application Publication
(10) Pub. No.: US 2014/0222731 A1
(43) Pub. Date: Aug. 7, 2014

(54) DISTRIBUTED ARCHITECTURE FOR LAYERED HIDDEN MARKOV MODELS

(71) Applicant: Cisco Technology, Inc., San Jose, CA (US)

(72) Inventors: Grégory Mermoud, Veyras (CH); Jean-Philippe Vasseur, Saint Martin d'Uriage (FR); Sukrit Dasgupta, Norwood, MA (US)

(73) Assignee: CISCO TECHNOLOGY, INC., San Jose, CA (US)

(21) Appl. No.: 13/955,722

(22) Filed: Jul. 31, 2013

Related U.S. Application Data
(60) Provisional application No. 61/761,135, filed on Feb. 5, 2013.

(51) Int. Cl. G06N 99/00

(52) U.S. Cl. CPC G06N 99/005
USPC 706/12

(57) ABSTRACT

In one embodiment, techniques are shown and described relating to a distributed architecture for layered Hidden Markov Models. In particular, in one embodiment, a Hidden Markov Model (HMM) at a layer i receives a sequence of hidden state produced by an HMM at a layer i−1, and uses the sequence of hidden state produced by the HMM at layer i−1 as input to the HMM at layer i, where the HMM at layer i−1 uses first time period bins, and the HMM at layer i uses second time period bins that are greater in length than the first time period bins. In another embodiment, the HMM at layer i originates the input (e.g., from measured properties), and produces the sequence of hidden state to output it to an HMM at a layer i+1 for use as its input.

### RELATED APPLICATION

The present invention claims priority to U.S. Provisional Application Ser. No. 61/761,135, filed Feb. 5, 2013, entitled “A DISTRIBUTED ARCHITECTURE FOR LAYERED HIDDEN MARKOV MODELS”, by Mermoud, et al., the contents of which are incorporated herein by reference.

### TECHNICAL FIELD

The present disclosure relates generally to computer networks, and, more particularly, to the use of learning machines within computer networks.

### BACKGROUND

Low power and Lossy Networks (LLNs), e.g., Internet of Things (IoT) networks, have a myriad of applications, such as sensor networks, Smart Grids, and Smart Cities. Various challenges are presented with LLNs, such as lossy links, low bandwidth, low quality transceivers, battery operation, low memory and/or processing capability, etc. The challenging nature of these networks is exacerbated by the large number of nodes (an order of magnitude larger than a “classic” IP network), thus making the routing, Quality of Service (QoS), security, network management, and traffic engineering extremely challenging, to mention a few.

Machine learning (ML) is concerned with the design and the development of algorithms that take as input empirical data (such as network statistics and states, and performance indicators), recognize complex patterns in these data, and solve complex problems such as regression (which are usually extremely hard to solve mathematically) thanks to modeling. In general, these patterns and computation of models are then used to make decisions automatically (i.e., close-loop control) or to help make decisions. ML is a very broad discipline used to tackle very different problems (e.g., computer vision, robotics, data mining, search engines, etc.), but the most common tasks are the following: linear and non-linear regression, classification, clustering, dimensionality reduction, anomaly detection, optimization, association rule learning.

One very common pattern among ML algorithms is the use of an underlying model M, whose parameters are optimized for minimizing the cost function associated to M, given the input data. For instance, in the context of classification, the model M may be a straight line that separates the data into two classes such that M=a*x+b*y+c and the cost function would be the number of misclassified points. The ML algorithm then consists in adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data. Note that the example above is an over-simplification of more complicated regression problems that are usually highly multi-dimensional.

Learning Machines (LMs) are computational entities that rely on one or more ML algorithm for performing a task for which they haven't been explicitly programmed to perform. In particular, LMs are capable of adjusting their behavior to their environment (that is, “auto-adapting” without requiring a priori configuring static rules). In the context of LLNs, and more generally in the context of the IoT (or Internet of Everything, IoE), this ability will be very important, as the network will face changing conditions and requirements, and the network will become too large for efficiently management by a network operator. In addition, LLNs in general may significantly differ according to their intended use and deployed environment.

Thus far, LMs have not generally been used in LLNs, despite the overall level of complexity of LLNs, where “classic” approaches (based on known algorithms) are inefficient or when the amount of data cannot be processed by a human to predict network behavior considering the number of parameters to be taken into account.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIG. 3 illustrates an example directed acyclic graph (DAG) in the communication network of FIG. 1;

FIG. 4 illustrates an example Bayesian network;

FIG. 5 illustrates an example signaling graph;

FIG. 6 illustrates an example Hidden Markov Model (HMM) represented by a Bayesian network;

FIG. 7 illustrates an example distributed architecture for layered HMMs;

FIG. 8 illustrates an example simplified procedure for providing a distributed architecture for layered Hidden Markov Models in accordance with one or more embodiments described herein; and

FIG. 9 illustrates another example simplified procedure for providing a distributed architecture for layered Hidden Markov Models in accordance with one or more embodiments described herein, particularly from the perspective of the lowest HMM layer.

### DESCRIPTION OF EXAMPLE EMBODIMENTS

### Overview

According to one or more embodiments of the disclosure, techniques are shown and described relating to a distributed architecture for layered Hidden Markov Models. In particular, in one embodiment, a Hidden Markov Model (HMM) at a layer i receives a sequence of hidden state produced by an HMM at a layer i−1, and uses the sequence of hidden state produced by the HMM at layer i−1 as input to the HMM at layer i, where the HMM at layer i−1 uses first time period bins, and the HMM at layer i uses second time period bins that are greater in length than the first time period bins. In another embodiment, the HMM at layer i originates the input (e.g., from measured properties), and produces the sequence of hidden state to output it to an HMM at a layer i+1 for use as its input.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE P1901.2, and others. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

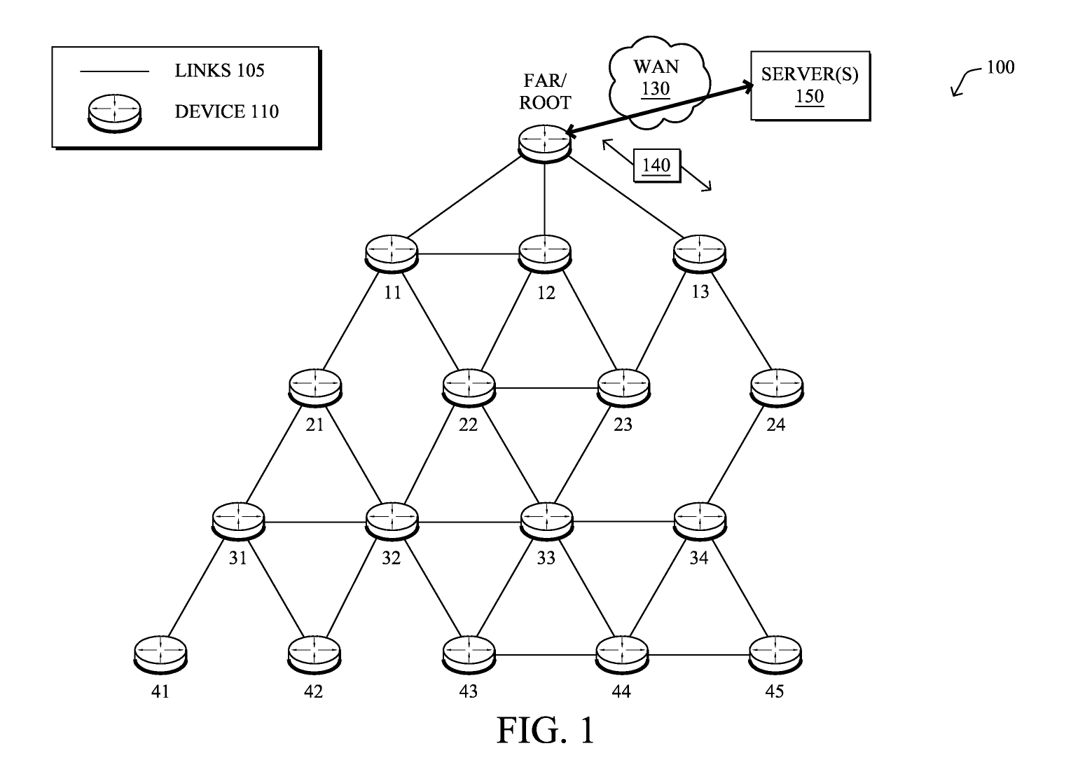

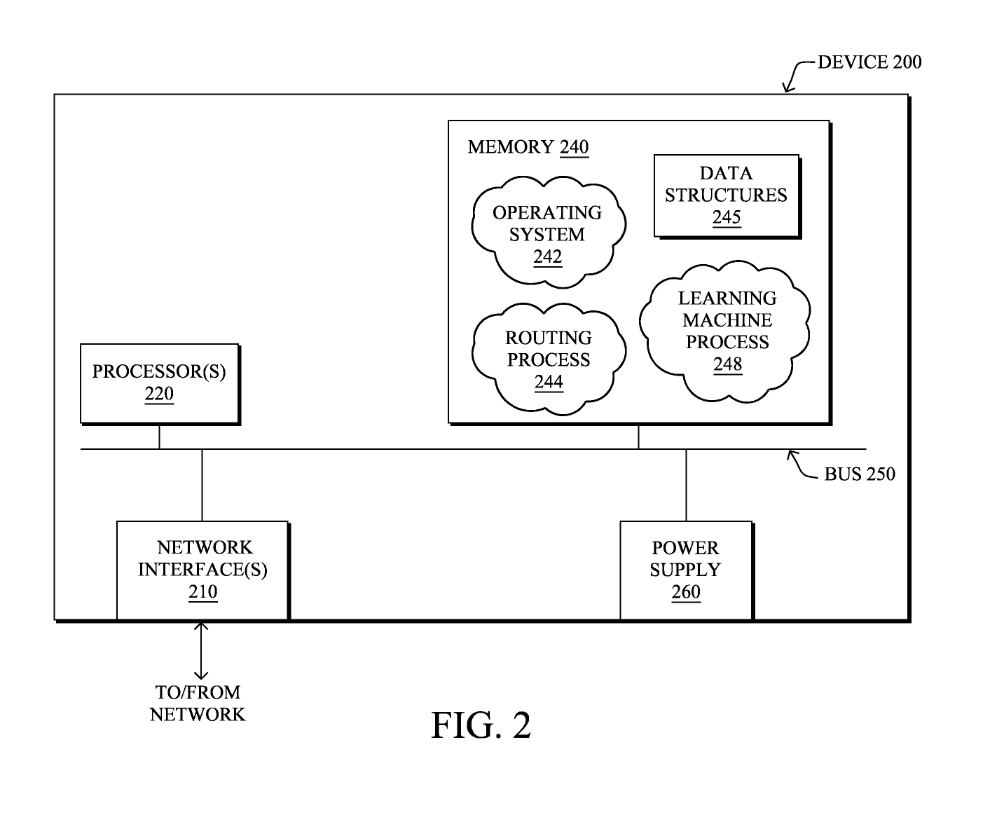

FIG. 1 is a schematic block diagram of an example computer network 100 illustratively comprising nodes/devices 110 (e.g., labeled as shown, “root,” “11,” “12,” . . . “45,” and described in FIG. 2 below) interconnected by various methods of communication. For instance, the links 105 may be wired links or shared media (e.g., wireless links, PLC links, etc.) where certain nodes 110, such as, e.g., routers, sensors, computers, etc., may be in communication with other nodes 110, e.g., based on distance, signal strength, current operational status, location, etc. The illustrative root node, such as a field area router (FAR) of a FAN, may interconnect the local network with a WAN 130, which may house one or more other relevant devices such as management devices or servers 150, e.g., a network management server (NMS), a dynamic host configuration protocol (DHCP) server, a constrained application protocol (CoAP) server, etc. Those skilled in the art will understand that any number of nodes, devices, links, etc. may be used in the computer network, and that the view shown herein is for simplicity. Also, those skilled in the art will further understand that while the network is shown in a certain orientation, particularly with a “root” node, the network 100 is merely an example illustration that is not meant to limit the disclosure.

Data packets 140 (e.g., traffic and/or messages) may be exchanged among the nodes/devices of the computer network 100 using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the nodes interact with each other.

FIG. 2 is a schematic block diagram of an example node/device 200 that may be used with one or more embodiments described herein, e.g., as any of the nodes or devices shown in FIG. 1 above. The device may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration. Also, while the network interface 210 is shown separately from power supply 260, for PLC (where the PLC signal may be coupled to the power line feeding into the power supply) the network interface 210 may communicate through the power supply 260, or may be an integral component of the power supply.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise a routing process/services 244 and an illustrative “learning machine” process 248, which may be configured depending upon the particular node/device within the network 100 with functionality ranging from intelligent learning machine algorithms to merely communicating with intelligent learning machines, as described herein. Note also that while the learning machine process 248 is shown in centralized memory 240, alternative embodiments provide for the process to be specifically operated within the network interfaces 210.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process (services) 244 contains computer executable instructions executed by the processor 220 to perform functions provided by one or more routing protocols, such as proactive or reactive routing protocols as will be understood by those skilled in the art. These functions may, on capable devices, be configured to manage a routing/forwarding table (a data structure 245) containing, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

Notably, mesh networks have become increasingly popular and practical in recent years. In particular, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point such at the root node to a subset of devices inside the LLN) and multipoint-to-point traffic (from devices inside the LLN towards a central control point).

An example implementation of LLNs is an “Internet of Things” network. Loosely, the term “Internet of Things” or “IoT” (or “Internet of Everything” or “IoE”) may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid, smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

An example protocol specified in an Internet Engineering Task Force (IETF) Proposed Standard, Request for Comment (RFC) 6550, entitled “RPL: IPv6 Routing Protocol for Low Power and Lossy Networks” by Winter, et al. (March 2012), provides a mechanism that supports multipoint-to-point (MP2P) traffic from devices inside the LLN towards a central control point (e.g., LLN Border Routers (LBRs), FARs, or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

Also, a directed acyclic graph (DAG) is a directed graph having the property that all edges are oriented in such a way that no cycles (loops) are supposed to exist. All edges are contained in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Note also that a tree is a kind of DAG, where each device/node in the DAG generally has one parent or one preferred parent. DAGs may generally be built (e.g., by a DAG process and/or routing process 244) based on an Objective Function (OF). The role of the Objective Function is generally to specify rules on how to build the DAG (e.g. number of parents, backup parents, etc.).

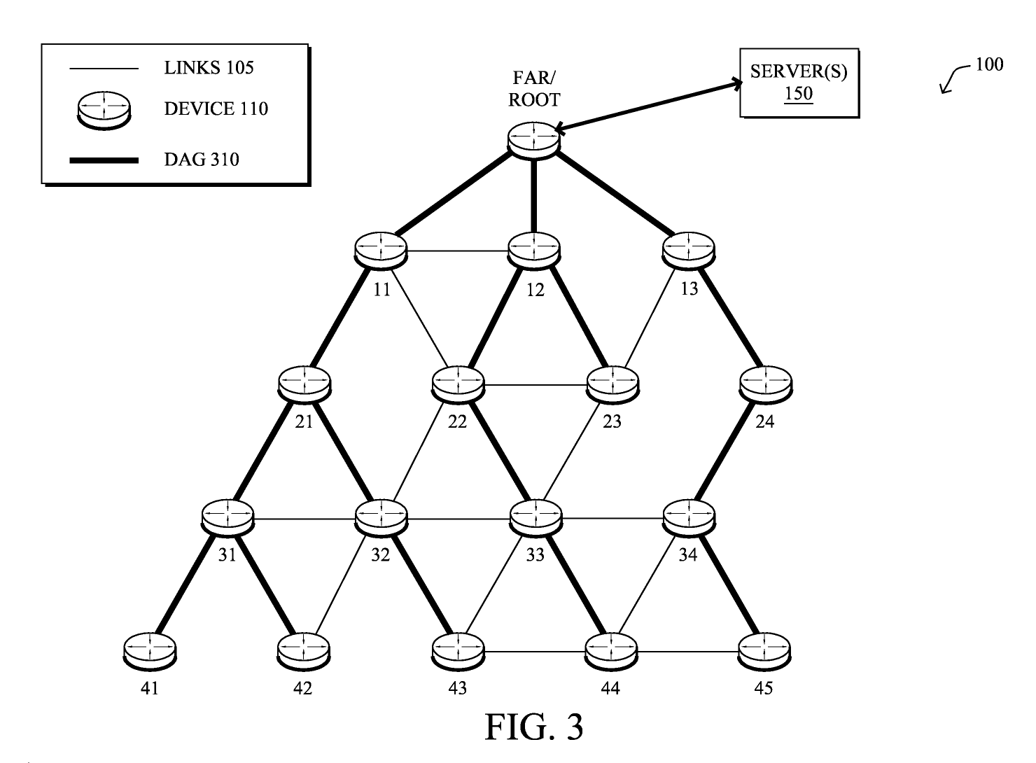

FIG. 3 illustrates an example simplified DAG that may be created, e.g., through the techniques described above, within network 100 of FIG. 1. For instance, certain links 105 may be selected for each node to communicate with a particular parent (and thus, in the reverse, to communicate with a child, if one exists). These selected links form the DAG 310 (shown as bolded lines), which extends from the root node toward one or more leaf nodes (nodes without children). Traffic/packets 140 (shown in FIG. 1) may then traverse the DAG 310 in either the upward direction toward the root or downward toward the leaf nodes, particularly as described herein.

Learning Machine Technique(s)

As noted above, machine learning (ML) is concerned with the design and the development of algorithms that take as input empirical data (such as network statistics and state, and performance indicators), recognize complex patterns in these data, and solve complex problem such as regression thanks to modeling. One very common pattern among ML algorithms is the use of an underlying model M, whose parameters are optimized for minimizing the cost function associated to M, given the input data. For instance, in the context of classification, the model M may be a straight line that separates the data into two classes such that M=a*x+b*y+c and the cost function would be the number of misclassified points. The ML algorithm then consists in adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

As also noted above, learning machines (LMs) are computational entities that rely one or more ML algorithm for performing a task for which they haven't been explicitly programmed to perform. In particular, LMs are capable of adjusting their behavior to their environment. In the context of LLNs, and more generally in the context of the IoT (or Internet of Everything, IoE), this ability will be very important, as the network will face changing conditions and requirements, and the network will become too large for efficiently management by a network operator. Thus far, LMs have not generally been used in LLNs, despite the overall level of complexity of LLNs, where “classic” approaches (based on known algorithms) are inefficient or when the amount of data cannot be processed by a human to predict network behavior considering the number of parameters to be taken into account.

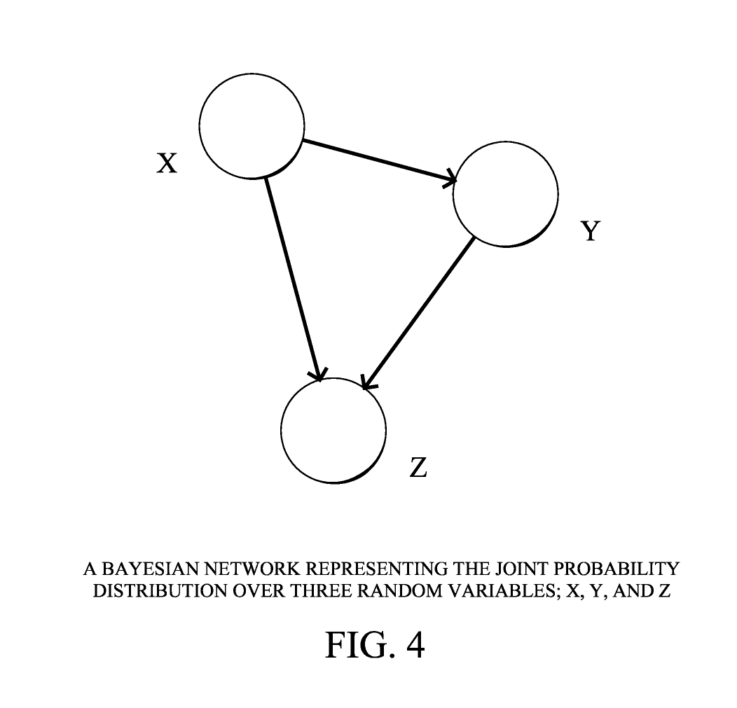

In particular, many LMs can be expressed in the form of a probabilistic graphical model also called Bayesian Network (BN). A BN is a graph G=(V,E) where V is the set of vertices and E is the set of edges. The vertices are random variables, e.g., X, Y, and Z (see FIG. 4) whose joint distribution P(X,Y,Z) is given by a product of conditional probabilities:

P(X,Y,Z)=P(Z|X,Y)P(Y|X)P(X) (Eq. 1)

The conditional probabilities in Eq. 1 are given by the edges of the graph in FIG. 4. In the context of LMs, BNs are used to construct the model M as well as its parameters.

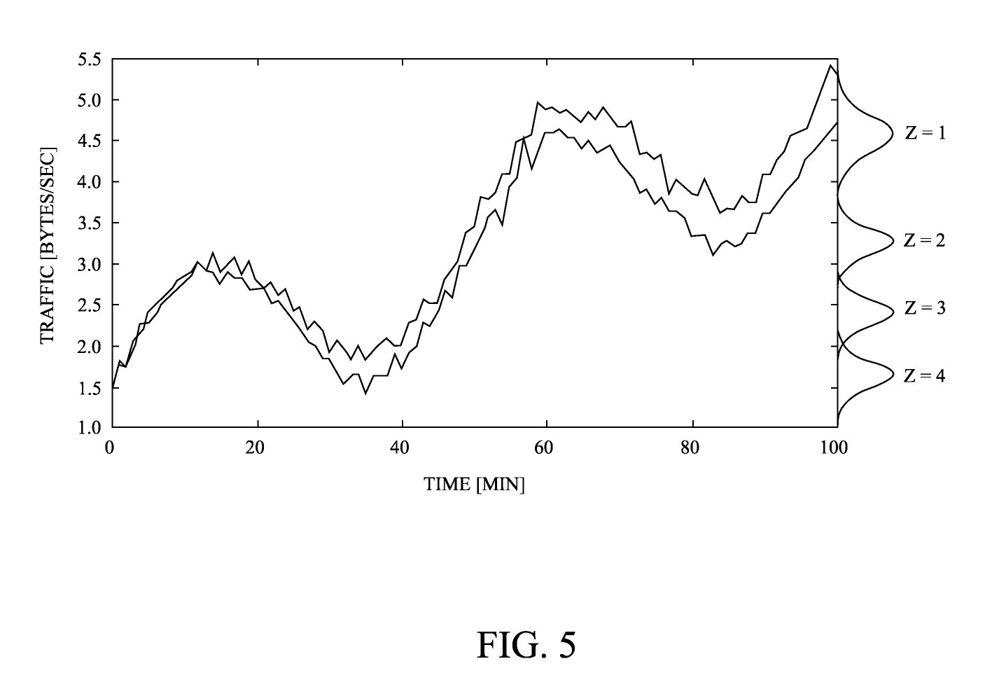

For instance, a common example of an ML algorithm that can be represented as a BN is the Hidden Markov Model (HMM). The HMM is essentially a probabilistic model of sequential data. To illustrate how an HMM works, the following example with reference to FIG. 5 is given:

is Each signal shown in FIG. 5 can be represented as a sequence of values x₁, x₂, . . . , x_{N}, with N=100 (each value xⱼ represents the average traffic in bytes/sec averaged over 1 minute). In an HMM, each value xᵢ is modeled as a random variable whose probability density function depends on an underlying,—hidden state—zᵢ that may take discrete values between 1 and K. In this example, K=4, and each of these states corresponds to a different traffic setting: z=1 corresponds to large traffic settings of 4 bytes per second and more whereas z=4 corresponds to small traffic settings. As a result, an HMM does not capture explicitly the dependence between xᵢ₊₁ and xᵢ; instead, it uses a Markov chain to model the sequence zᵢ, z₂, . . . z_{N}.

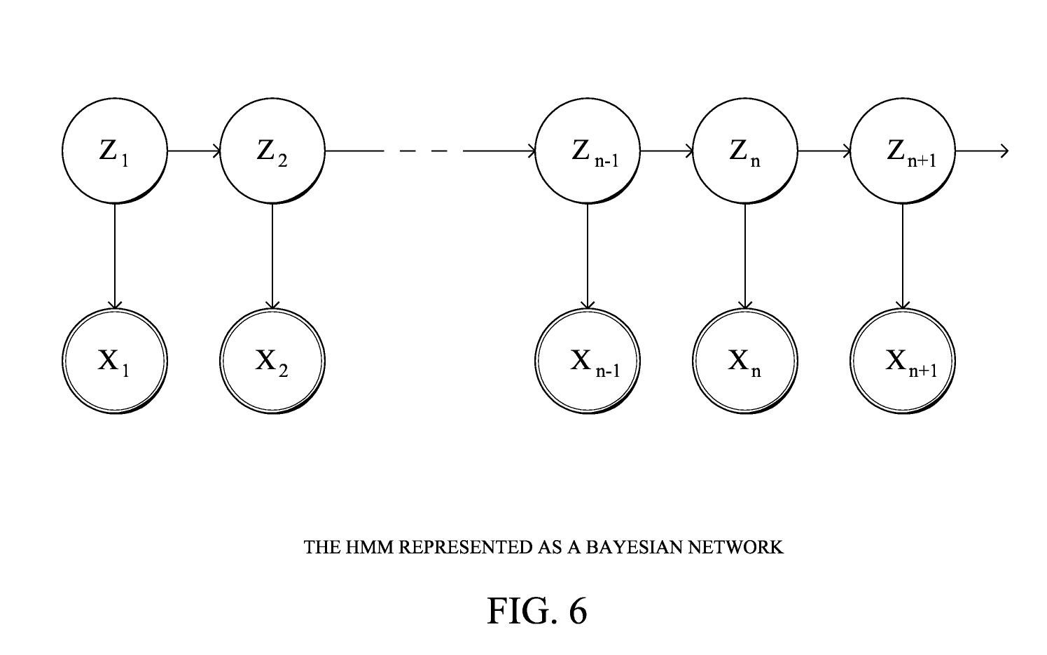

In other words, the probability distribution of zₙ depends on zₙ₋₁, and is given by a K×K transition matrix A=(Aᵢⱼ) where Aᵢⱼ=P(zₙ=j|zₙ₋₁=i). The model assumes that the observed data are random variables Xᵢ whose distribution depends on the underlying state zᵢ, and is called an emission probability. As a result, an HMM can be represented by the BN shown in FIG. 6.

Importantly, the states zᵢ cannot be observed, which is why they are called hidden states. Instead, their value can be inferred from empirical data. The parameters of the HMM (i.e., the number of hidden states, the transition matrix A and the emission probabilities) may either be explicitly defined according to prior knowledge of the system, or they can be learned from empirical data. The latter usage is more typical, and is generally achieved by estimating and maximizing the likelihood of the HMM with respect to existing data (called the learning data set). If a learning data set x={x₁, . . . , x_{N}}, the likelihood function is given by:

p(x|θ)=Σ_{z}(x,z|θ)

where θ represents the parameters of the HMM. One of the key challenges in maximizing this likelihood function is that the state variables zᵢ are unknown. As a result, one needs to perform the summation over all K possible values of zᵢ for i=1, . . . , N, which results in K^{N} terms. This approach becomes rapidly intractable as both K and N grows; instead, one can use the expectation maximization (EM) algorithm to solve this problem. In other words, the EM algorithm adopts an iterative approach in which two successive steps are applied until convergence. The E-step estimates the expected value of the likelihood function with respect to the conditional distribution of Z given X, under the current estimate of the parameters θ^{(t)}:

Q(θ|θ^{(t)})=E_{z|x,θ(t)}[p(x,z|θ]

Computing this quantity no longer requires performing the summation over all values of all variables of Z. The M-step then maximizes this function:

θ^{(t+1)}=arg max_{θ} Q(θ|θ^{(t)})

where arg maxₓ f(x) returns the parameter x that maximizes f(x).

Now, it can be shown that the sequence θ⁽⁰⁾, θ⁽¹⁾, θ⁽²⁾, converges to some local minimum of the likelihood function. As a result, the EM algorithm must generally be executed multiple times with different initial conditions.

In the example shown in FIG. 5, one would train the HMM based on data of type A (lower values). The EM algorithm would adjust both the mean and the variance of the Gaussian distributions that describe the emission probabilities for zᵢ=k with k=1, . . . , 4 in such a way that the whole spectrum of values found in the input data is covered in some statistically optimal way. In parallel, the algorithm will generate a transition rates Aₖ₁ describing the transition from one state zᵢ₊₁=k to the next zᵢ=1 such that the input sequence could have likely been generated by this Markov chain.

Together with BNs, the EM algorithm is one central piece of the mathematical framework used for designing and implementing LMs. By modifying the structure of the BN and updating the EM algorithm accordingly, one can obtain LMs with very different features and capabilities, as well as very different computational costs. BNs and HMMs are generally known learning machine algorithms, and the specifics described herein are merely examples for illustration.

Notably, many routine tasks in LLNs need to be executed only in suitable traffic conditions. For instance, when one is interested in monitoring the QoS of a given node, the probes need to be sent at times where the traffic is representative of a normal activity. In other scenarios, one is interested in predicting quiet periods for carrying out maintenance tasks or start gathering network management data for example since the LM has predicted that there will be a quiet period that can advantageously be used to carry control plane traffic (e.g., firmware update, shadow joining, reboots, etc.).

U.S. Provisional Patent Application Ser. No. 61/761,134, entitled “A Hidden Markov Model Based Architecture to Monitor Network Node Activities and Predict Relevant Periods”, filed by Mermoud et al. on Feb. 5, 2013, describes an HMM-based architecture to analyze various traffic flows (user traffic, control plane, etc.) so as to detect and classify node activities (e.g., firmware upgrade, wireless personal area network (WPAN) joining, meter reading, various applications, etc.) and predict so-called “relevant” periods, that is, time intervals that are of particular interest for a given task. However, it utilizes several instances of HMM M₁, M₂, . . . , Mₙ for capturing the different patterns, where each pattern is associated to a different own time scale and duration. Generally speaking, this approach requires various computationally intensive aspects.

The techniques herein, however, use a distributed layered architecture evolving computing tasks on multiple routers in which each layer is responsible for the analysis of a large number of different patterns, but focusing only on a single time scale at each layer. The output of each layer is forwarded to the next one. As the hierarchy is ascended, the time granularity becomes coarser, but this allows the capture of longer patterns, possibly with more long-range correlations. It is critical to understand that such a layering approach allows for very long term pattern recognition, a task not possible on a single low-end platform. Another critical advantage of this approach lies in its inherent distributed nature. Indeed, each layer could be hosted on a different router. Such an architecture is meaningful for several reasons: (1) low-level layers have the finest time granularity, and therefore require lower latencies and larger bit-rates, (2) as the hierarchy is ascended, each layer serves as a compression engine (by reducing the dimensionality of the data, as explained below), and they require less frequent samples as their corresponding time granularity is coarser, and (3) each layer can be learned independently from the other, in an asynchronous manner.

Said differently, the techniques herein introduce an architecture for layered HMMs that reduces the computational cost by distributing the learning and execution of each layer on multiple routers across the network. Each layer processes the data for a given time scale: at the lowest level, the time granularity is the smallest, and it coarsens gradually as one moves up the hierarchy of layers, still while maintaining the level of complexity of the problem space. By converting sequences of highly dimensional input data into sequences of discrete states, each layer operates a dimensionality reduction, which allows one to maintain a low bandwidth usage across the whole network. Protocol extensions are used in order to determine according to policy the number of involved layers along with the characteristics of HMM at each layer; extensions of an Offloading Computation Selection (OCS) engine are specified in order to dynamically distribute the set of layers in the network. Overall, this invention allows for a larger scalability of HMM-based algorithms in large LLNs, in particular when dealing with processes that involve many different time scales.

Illustratively, the techniques described herein may be performed by hardware, software, and/or firmware, such as in accordance with the learning machine process 248, which may contain computer executable instructions executed by the processor 220 (or independent processor of interfaces 210) to perform functions relating to the techniques described herein, e.g., optionally in conjunction with other processes. For example, certain aspects of the techniques herein may be treated as extensions to conventional protocols, such as the various communication protocols (e.g., routing process 244), and as such, may be processed by similar components understood in the art that execute those protocols, accordingly. Also, while certain aspects of the techniques herein may be described from the perspective of a single node/device, embodiments described herein may be performed as distributed intelligence, also referred to as edge/distributed computing, such as hosting intelligence within nodes 110 of a Field Area Network in addition to or as an alternative to hosting intelligence within servers 150.

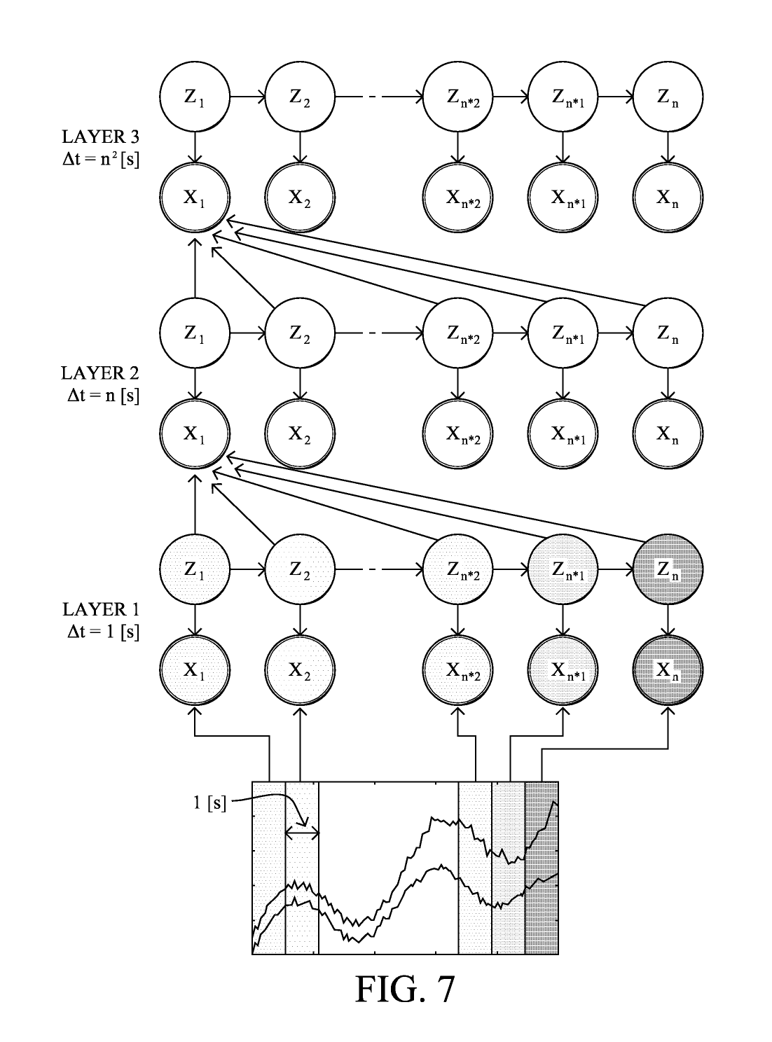

Operationally, the techniques herein adopt a specific layered architecture for dealing with the multiple time scales characterizing LLNs. In contrast with other approaches, the techniques herein do not require multiple HMMs at each level. Rather, a single HMM is assumed to be sufficiently versatile to capture the dynamics at a particular time scale (of course, it has to be designed in such a way that this assumption holds, that is, the number of states must be sufficient while avoiding over-fitting). Then, the techniques herein use the sequence of hidden state produced by Mᵢ as an input to the HMM Mᵢ₊₁, located at the next level. More specifically, with reference to FIG. 7, at the bottom, the first layer contains an HMM with very small time granularity (for instance, with Δt=1 s), whose hidden state sequence z₁=[z_{1,1}, . . . , z_{1,n}] is used as the input x₂ to the HMM at the second layer. As a result, if the length of a sequence is restricted to 10 bins at the first layer (without loss of generality), then the second layer may illustratively operate on a time scale Δt=10 s, and the M-th layer will operate on a time scale of Δt=10^{M-1} s. Doing so, only six layers are necessary to obtain an architecture that can reliably track patterns over an entire week.

Two important details need to be noted with respect to this layered architecture. First, the input sequence x₁ to the first layer is typically a sequence of some measured properties of a node (e.g., the traffic, the flappiness, the stickiness, or the hop count), possibly continuous, whereas the input sequence xᵢ to the higher level layers (i.e., for i>1) is a sequence of hidden states, whose values are discrete. Second, and optionally, it may be possible to further reduce the dimensionality operated by moving from one level to the next by using a local classifier, and transmitting solely the output of this classifier. For instance, at the first level, one may attempt to distinguish between different short-term evolution such as “flat line”, “slight increase”, “strong increase”, “short oscillation”, etc. One would then transmit only the type of pattern to the next level, thereby allowing the second layer to deal with a much-simplified input space.

As an example, if one is interested in identifying traffic patterns using the techniques herein, the first layer would take chunks of traffic data (each chunk being the average traffic over 1 second), and its output would be a sequence of discrete hidden states. Each sequence could then be classified into, say, seven categories representing the various possible traffic variations over a 10-second time interval (assuming that the sequence length is 10). Typically, as mentioned earlier, these seven categories could be “flat line”, “slight increase”, “strong increase”, “slight decrease”, “strong decrease”, “u-shaped”, “n-shaped”, etc. Alternatively, in a more typical use of HMMs, there would be seven different HMMs, each being trained for recognizing a different category of signal. However, conceptually, both approaches are valid and identical, and the consequence is that the second layer will be treating as input a sequence of the type: “flat line”, “slight increase”, “slight increase”, . . . , “strong decrease”, etc. This sequence being composed of building blocks that represent 10-second intervals, it effectively spans a much larger time interval (100 sec in this case). Now, the corresponding sequence of hidden states at the second layer can be, again, classified into various categories. This time, their labels are no longer merely descriptive, but they may pinpoint actual tasks, such as “standby”, “authentication”, “meter reading”, “wpan joining”, “firmware update”, “application A”, “application B”, etc. Similarly, at the third layer, the techniques herein now illustratively consider sequences that span about 15 minutes, and the categories may denote much higher-level concepts. For instance, a sequence “wpan joining”, “authentication”, “standby”, “meter reading”, etc. may be considered as normal whereas “wpan joining”, “standby”, “meter reading” is abnormal, as it would indicate that the meter hasn't authenticated.

In other words, by having each layer operate at a different time scale and providing an output of a different nature (because of the time scale difference), it becomes possible to handle very large time frame in a highly scalable fashion and perform complex long timeframe pattern recognition in LLNs. It also allows the detection of events that are periodic in different time scales. For example, an event might seem to be a random occurrence in a short time frame of a day, but it could turn out that it is periodic in the time frame of months.

This architecture raises the question of the number of layers that is required for a particular task. Notably, the techniques herein propose a dynamic deployment of a layered HMM where a policy manager is responsible for determining the number of N of required layers in addition to their respective properties (i.e., number of hidden states, size of the state space, number of categories for the classification). The policies are user-defined as a function of the task at hand. To that end, the techniques herein specify two components:
A configuration agent hosted on the NMS specifying, for each task T performed by a Learning Machine M of HMM type, the number N of involved layer along with a set S of properties at each layer.
Upon DHCP registration, the Field Area Router (FAR) would retrieve thanks to a newly specified DHCP extension the various parameters T, N and S. Alternatively, the techniques propose to specify a CoAP message sent by the NMS to the FAR, should a new HMM be instantiated after the registration process.

In terms of deployment, a layer may be added to the architecture only when lower-level layers are properly trained and yield accurate hidden sequences. As a result, there is a clear, incremental policy in terms of deployment. When to stop adding layers may be guided by the performance with respect to the task of interest.

The learning of the layered HMMs may be performed in an unsupervised manner, from the bottom up. Each layer is trained independently from the other with the EM algorithm, which does not require any modification. When a given layer L is properly trained, its output can be used to train the layer L+1, and so on. Because input observations are n-dimensional vectors and hidden states are scalar, a single layer operates a reduction of dimensionality from n to 1, but this reduction is canceled out by the fact that we aggregate the hidden states in time, thereby maintaining a constant dimensionality throughout the whole hierarchy of HMMs.

Regarding the discovery process and information sharing among HMMs, for the reason exposed in U.S. Provisional Patent Application Ser. No. 61/761,132, entitled “A Distributed Architecture for Machine Learning Based Computation Using a Decision Control Point” filed by Vasseur et al. on Feb. 5, 2013, a classic resource discovery approach consisting in using IGP protocol extension to dynamically discover the set of routers that could host layers is ill-suited for this type of computation. Accordingly, the techniques herein propose for the FAR hosting the HMM (layer-1) to make use of an Offloading Computation Selection (OCS) engine (see U.S. Provisional Patent Application Ser. No. 61/761,132) to discover the set of routers K used to host the N layers. Note that in a typical IoT environment, one may want to distribute the layers in such a way that the lower-level layers, which have the finest time granularity, are the closest to the objects, thereby reducing the delay, and the higher level layers with the coarsest time granularity are close to the Network Operation Center (NOC). To that end, the techniques herein specify a newly defined TLV comprising the information related to the task T, number of layers N, and set S of properties sent by the requesting FAR to the OCS.

Notably, since the layered architecture herein involves only one HMM per layer, classification cannot be performed without a further mechanism. The approach proposed here is to use a third-party classifier (e.g., a neural network, a support vector machine, or a relevance vector machine) that would take as input the sequence of hidden states z_{L} at layer L, and infer the type of traffic based on these data. However, in the context of the embodiments herein, an explicit classification of the type of traffic is not necessarily required; instead, one might simply use the layered HMMs to complete partial input vectors x_{1:k}, and thereby determine optimal networking policies.

Depending on the local computational resources, one may store more than one layer on a single router. In one embodiment, a single router may host M<N of the layers; in another embodiment, the N layers may be distributed on K Routers where N<=K.

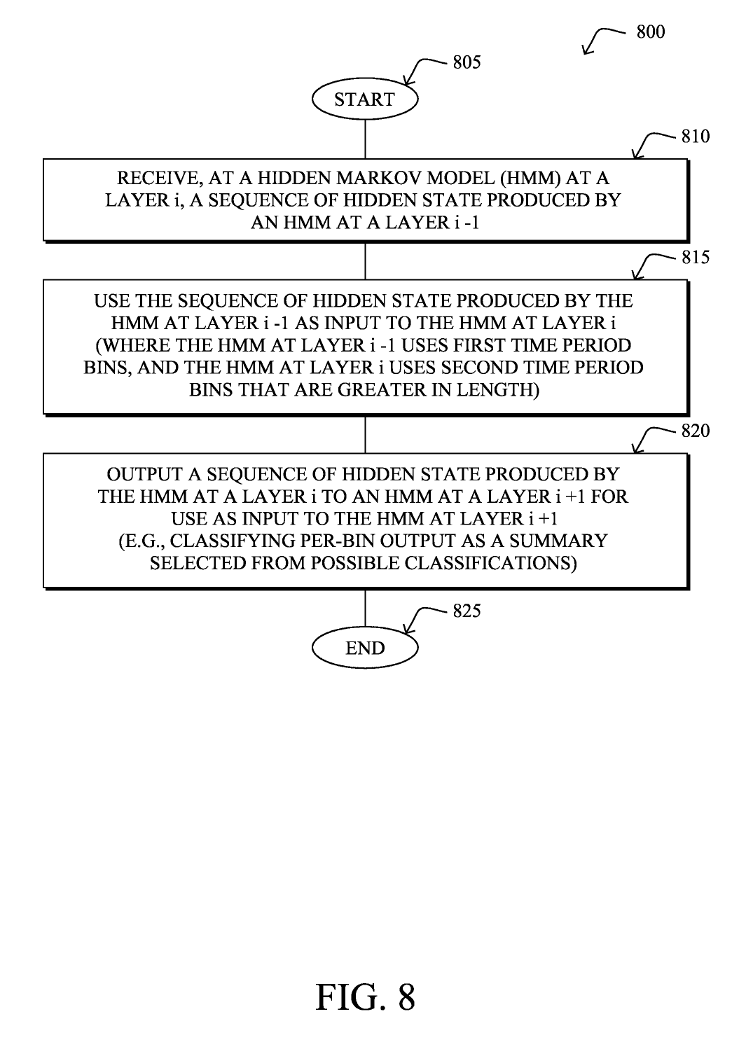

FIG. 8 illustrates an example simplified procedure 800 for providing a distributed architecture for layered Hidden Markov Models in accordance with one or more embodiments described herein. The procedure 800 may start at step 805, and continues to step 810, where, as described in greater detail above, a Hidden Markov Model (HMM) at a layer i receives a sequence of hidden state produced by an HMM at a layer i−1 (e.g., a lowest layer having input that comprises measured properties, such as measured computer network traffic properties). In step 815, the sequence of hidden state produced by the HMM at layer i−1 is used as input to the HMM at layer i, where as noted, the HMM at layer i−1 uses first time period bins, and the HMM at layer i uses second time period bins that are greater in length than the first time period bins. (For example, in one embodiment, the HMM at layer i−1 uses first time period bins for a first number of bins, and the HMM at layer i uses second time period bins that equal the first time period multiplied by the first number.)

In step 820 a sequence of hidden state produced by the HMM at a layer i may be outputted to an HMM at a layer i+1 for use as input to the HMM at layer i+1 (e.g., classifying per-bin output as a summary selected from possible classifications, such as, for example, flat line, slight/strong increase/decrease, n/u-shaped change, oscillation, or any other qualitative description of a portion of a signal, as well as standby, authentication, meter reading, WPAN joining, firmware update, and a particular application type of a plurality of application types, etc.). Note also that in one embodiment, the HMM at layer i may use second time period bins for a second number of bins, and the HMM at layer i+1 uses third time period bins that equal the second time period multiplied by the second number, as described in detail above. The procedure 800 illustratively ends in step 825, though notably with the ability to continue receiving input and outputting values, accordingly.

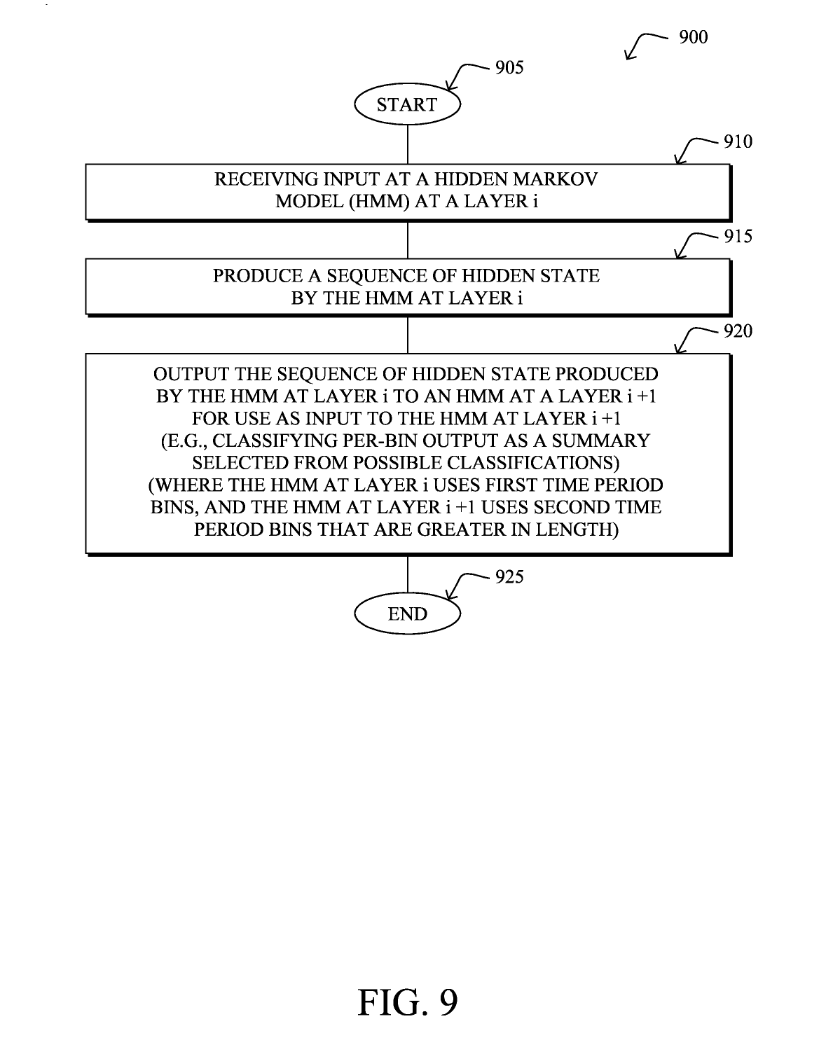

In addition, as an alternative perspective, FIG. 9 illustrates another example simplified procedure 900 for providing a distributed architecture for layered Hidden Markov Models in accordance with one or more embodiments described herein, particularly where the layer i is the lowest layer. The procedure 900 may start at step 905, and continues to step 910, where, as described in greater detail above, a Hidden Markov Model (HMM) at a layer i may receive input, which can be used to produce a sequence of hidden state in step 915. In this example procedure, the input to the HMM at layer i comprises measured properties (e.g., measured computer network traffic properties), while receiving a sequence of hidden state produced by an HMM at a layer i−1 as the input is demonstrated in procedure 800 of FIG. 8 above. From the perspective of FIG. 9, in step 920 the sequence of hidden state produced by the HMM at layer i may be output to an HMM at a layer i+1 for use as input to the HMM at layer i+1 (e.g., classifying per-bin output as a summary selected from possible classifications), where again the HMM at layer i uses first time period bins, and the HMM at layer i+1 uses second time period bins that are greater in length than the first time period bins (e.g., where the HMM at layer i uses first time period bins for a first number of bins, and the HMM at layer i+1 uses second time period bins that equal the first time period multiplied by the first number). The procedure 900 illustratively ends in step 925.

It should be noted that while certain steps within procedures 800-900 may be optional as described above, the steps shown in FIGS. 8-9 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 800-900 are described separately, certain steps from each procedure may be incorporated into each other procedure, and the procedures are not meant to be mutually exclusive. Still further, as noted above, the techniques in procedures 800-900 may be performed where all HMM layers are located on a single device, or where HMM layers are distributed among a plurality of devices. Also, as described above, it is possible in either procedure 800 or 900 to determine a number of layers to use (e.g., one-time or dynamically based on need), and to configure the number of layers of HMMs, as described above.

The techniques described herein, therefore, provide for a distributed architecture for layered Hidden Markov Models. In particular, compared to conventional HMM-based approaches, the techniques herein are easily distributed across the network, thereby reducing computational cost at the level of each router while maintaining a low bandwidth usage. Furthermore, the techniques herein specify an architecture that lower-level layers with fine time granularity close to the LLNs themselves, where low latencies are required.

While there have been shown and described illustrative embodiments that provide for a distributed architecture for layered Hidden Markov Models, it is to be understood that various other adaptations and modifications may be made within the spirit and scope of the embodiments herein. For example, the embodiments have been shown and described herein with relation to LLNs and related protocols. However, the embodiments in their broader sense are not as limited, and may, in fact, be used with other types of communication networks and/or protocols. In addition, while the embodiments have been shown and described with relation to learning machines in the specific context of communication networks, certain techniques and/or certain aspects of the techniques may apply to learning machines in general without the need for relation to communication networks, as will be understood by those skilled in the art.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
receiving, at a Hidden Markov Model (HMM) at a layer i, a sequence of hidden state produced by an HMM at a layer i−1;
using the sequence of hidden state produced by the HMM at layer i−1 as input to the HMM at layer i;
wherein the HMM at layer i−1 uses first time period bins; and
wherein the HMM at layer i uses second time period bins that are greater in length than the first time period bins.

2. The method as in claim 1, wherein the HMM at layer i−1 uses first time period bins for a first number of bins, and wherein the HMM at layer i uses second time period bins that equal the first time period multiplied by the first number.

3. The method as in claim 1, further comprising:
outputting a sequence of hidden state produced by the HMM at a layer i to an HMM at a layer i+1 for use as input to the HMM at layer i+1.

4. The method as in claim 3, wherein the HMM at layer i uses second time period bins for a second number of bins, and wherein the HMM at layer i+1 uses third time period bins that equal the second time period multiplied by the second number.

5. The method as in claim 3, wherein outputting comprises:
classifying per-bin output as a summary selected from possible classifications.

6. The method as in claim 5, wherein the possible classifications are selected from a group consisting of: flat line; slight increase, strong increase; slight decrease; strong decrease; n-shaped change; u-shaped change; and oscillation.

7. The method as in claim 5, wherein the possible classifications are selected from a group consisting of: standby, authentication, meter reading, WPAN joining, firmware update, and a particular application type of a plurality of application types.

8. The method as in claim 1, wherein input to the HMM at layer i−1 comprises measured properties.

9. The method as in claim 1, wherein input to an HMM at a lowest layer comprises measured computer network traffic properties.

10. The method as in claim 1, wherein the input to the HMM at layer i comprises a classified summary of per-bin output from the HMM at layer i−1.

11. The method as in claim 1, further comprising:
determining a number of layers to use; and
configuring the number of layers of HMMs.

12. The method as in claim 1, wherein all HMM layers are located on a single device.

13. The method as in claim 1, wherein HMM layers are distributed among a plurality of devices.

14. A method, comprising:
receiving input at a Hidden Markov Model (HMM) at a layer i;
producing a sequence of hidden state by the HMM at layer i;
outputting the sequence of hidden state produced by the HMM at layer i to an HMM at a layer i+1 for use as input to the HMM at layer i+1;
wherein the HMM at layer i uses first time period bins; and
wherein the HMM at layer i+1 uses second time period bins that are greater in length than the first time period bins.

15. The method as in claim 14, further comprising:
receiving, at the HMM at layer i, a sequence of hidden state produced by an HMM at a layer i−1 as the input.

16. The method as in claim 15, wherein the input to the HMM at layer i comprises a classified summary of per-bin output from the HMM at layer i−1.

17. The method as in claim 14, wherein the HMM at layer i uses first time period bins for a first number of bins, and wherein the HMM at layer i+1 uses second time period bins that equal the first time period multiplied by the first number.

18. The method as in claim 14, wherein outputting comprises:
classifying per-bin output as a summary selected from possible classifications.

19. The method as in claim 14, wherein input to the HMM at layer i comprises measured properties.

20. The method as in claim 14, wherein input to an HMM at a lowest layer comprises measured computer network traffic properties.

21. The method as in claim 14, wherein all HMM layers are located on a single device.

22. The method as in claim 14, wherein HMM layers are distributed among a plurality of devices.

23. An apparatus, comprising:
one or more network interfaces to communicate with a computer network;
a processor coupled to the network interfaces and adapted to execute one or more processes; and
a memory configured to store a process executable by the processor, the process when executed operable to:
receive, as a Hidden Markov Model (HMM) at a layer i, a sequence of hidden state produced by an HMM at a layer i−1;
use the sequence of hidden state produced by the HMM at layer i−1 as input to the HMM at layer i;
wherein the HMM at layer i−1 uses first time period bins; and
wherein the HMM at layer i uses second time period bins that are greater in length than the first time period bins.

24. An apparatus, comprising:
one or more network interfaces to communicate with a computer network;
a processor coupled to the network interfaces and adapted to execute one or more processes; and
a memory configured to store a process executable by the processor, the process when executed operable to:
receive input as a Hidden Markov Model (HMM) at a layer i;
produce a sequence of hidden state by the HMM at layer i;
output the sequence of hidden state produced by the HMM at layer i to an HMM at a layer i+1 for use as input to the HMM at layer i+1;
wherein the HMM at layer i uses first time period bins; and
wherein the HMM at layer i+1 uses second time period bins that are greater in length than the first time period bins.
